(19) United States
(12) Patent Application Publication
(10) Pub. No.: US 2011/0032577 A1
(43) Pub. Date: Feb. 10, 2011

(54) IMAGE RECORDING APPARATUS AND CONTROLLING METHOD THEREOF

(75) Inventor: Tomoko GOCHO, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: OLYMPUS CORPORATION, Tokyo (JP)

(21) Appl. No.: 12/909,097

(22) Filed: Oct. 21, 2010

Related U.S. Application Data
(63) Continuation of application No. PCT/JP2009/001580, filed on Apr. 6, 2009.

(30) Foreign Application Priority Data
May 1, 2008 (JP) 2008-119604

(51) Int. Cl. H04N 1/23

(52) U.S. Cl. 358/304

(57) ABSTRACT

A first surface image expanding unit and a second surface image expanding unit respectively execute an expansion process for expanding recording data of a plurality of pages of both surfaces into a dot image of each page and for holding the dot image. A post-processing mechanism includes at least a cutting information generating unit for generating cutting information of a continuous sheet, and cuts the continuous sheet at predetermined intervals. A continuous sheet conveyance controlling unit generates an unrecorded portion, on which an image recording process is not executed, on the continuous sheet in synchronization with the cutting information if it is determined that a delay has occurred within a time of the expansion process, which is identified in advance, on the basis of a count value of the number of pages of expanded image data held by the expansion process.

### CROSS REFERENCE TO RELATED APPLICATIONS

This is a Continuation Application of PCT Application No. PCT/JP2009/001580 filed Apr. 6, 2009, which was not published under PCT Article 21(2) in English.

This application is based upon and claims the benefit of priority from the prior Japanese Patent Application No. 2008-119604, filed May 1, 2008, the entire contents of which are incorporated herein by this reference.

### BACKGROUND OF THE INVENTION

1. Field of the Invention

The present invention relates to an image recording technique, and more particularly, to a technique of controlling an image recording process on both surfaces of a recording medium that is a continuous sheet.

2. Description of the Related Art

One example of an image recording apparatuses is, for example, an inkjet printer. An inkjet printer performs image recording at a high speed and with a high image quality by jetting ink droplets from a plurality of nozzles of recording heads onto a recording medium that is held and conveyed by a conveyance system.

Inkjet printers are widely used for office purposes, for example performing image recording on a recording medium (such as paper) in the form of a cut sheet. In recent years, there have been inkjet printers for which the throughput has been improved by configuring a line head where many recording heads are aligned in a direction orthogonal to a conveyance direction of a recording medium. Such inkjet printers are also used for industrial purposes such as performing image recording on a recording medium (continuous paper) that is a continuous sheet such as roll paper or the like.

There are cases where image recording cannot be properly performed due to an occurrence of a problem in a process of image recording data during a recording process in an image recording apparatus for performing image recording on a recording medium that is a continuous sheet. If image recording is aborted or suspended in such cases, a recording medium on which image recording has already been performed, and extra media at image recording suspension and at image recording restarting, are wasted as discarded media at the same time that an image recording throughput is significantly deteriorated. This leads to a great disadvantage to a user.

As a technique of solving such a problem, International Publication Pamphlet No. 04/056578 for example discloses a technique of preventing image recording from being aborted even in the above described cases. With this technique, an image recording process is continued up to the last piece of image recording data by taking a page on which image recording is to be performed and outputting it unchanged as a blank page with no image recording performed on the page with image recording data that cannot be properly read instead of aborting the image recording.

### SUMMARY OF THE INVENTION

An image recording apparatus in one aspect of the present invention is an image recording apparatus that includes an image expanding unit for executing an expansion process for expanding, into a dot image of each page, recording data of a plurality of pages on which an image recording process is to be executed and for holding the dot image, and that executes the image recording process by jetting ink onto a continuous sheet, which is a conveyed recording medium, from a recording head on the basis of the dot image. The image recording apparatus comprises: a post-processing mechanism having at least a cutting information generating unit for generating cutting information that indicates cutting timing of the continuous sheet, for cutting the continuous sheet at predetermined intervals; and a continuous sheet conveyance controlling unit for determining whether or not a delay has occurred within an expansion processing time that is identified in advance for the image expanding unit and is needed for the expansion process on the basis of a count value obtained by counting the number of pages of expanded image data held by the expansion process executed by the image expanding unit, and for generating on the continuous sheet an unrecorded portion on which the image recording process is not executed if it is determined that the delay has occurred. In the image recording apparatus, the continuous sheet conveyance controlling unit generates the unrecorded portion on the continuous sheet in synchronization with the cutting information generated by the cutting information generating unit.

A controlling method of an image recording apparatus in another aspect of the present invention is a controlling method of an image recording apparatus that includes an image expanding unit for executing an expansion process for expanding into a dot image of each page recording data of a plurality of pages on which an image recording process is to be executed and for holding the dot image, and that executes the image recording process by jetting ink onto a continuous sheet that is a conveyed recording medium from a recording head on the basis of the dot image. The image recording apparatus includes at least a cutting information generating unit for generating cutting information that indicates a cutting timing of the continuous sheet, and a post-processing mechanism for cutting the continuous sheet at predetermined intervals. The controlling method comprises: determining whether or not a delay has occurred within an expansion processing time that is identified in advance for the image expanding unit and that is needed for an expansion process on the basis of a count value obtained by counting the number of pages of expanded image data held by the expansion process executed by the image expanding unit; and generating an unrecorded portion, on which the image recording process is not executed, on the continuous sheet in synchronization with cutting information generated by the cutting information generating unit if it is determined that the delay has occurred.

### BRIEF DESCRIPTION OF THE DRAWINGS

The present invention will be more apparent from the following detailed description when the accompanying drawings are referenced.

FIG. 1 illustrates an image recording apparatus according to an embodiment as a conceptual block configuration;

FIG. 2 schematically illustrates an arrangement configuration of the image recording apparatus according to the embodiment;

FIG. 3 illustrates a data structure of sheet information;

FIG. 4 is an explanatory view of a process executed by a continuous sheet conveyance controlling unit;

FIG. 5 illustrates a data structure of conveyance control information for image recording;

FIG. 6 schematically illustrates results of image recording performed on a continuous sheet under normal conditions;

FIG. 7 illustrates a data structure of conveyance control information for generating a blank sheet;

FIG. 8 schematically illustrates results of image recording on a continuous sheet, and results of ejection of a continuous sheet after being cut under abnormal conditions; and

FIG. 9 is a flowchart illustrating a conveyance control information generation process.

### DESCRIPTION OF THE PREFERRED EMBODIMENTS

An embodiment according to the present invention is described below with reference to the drawings.

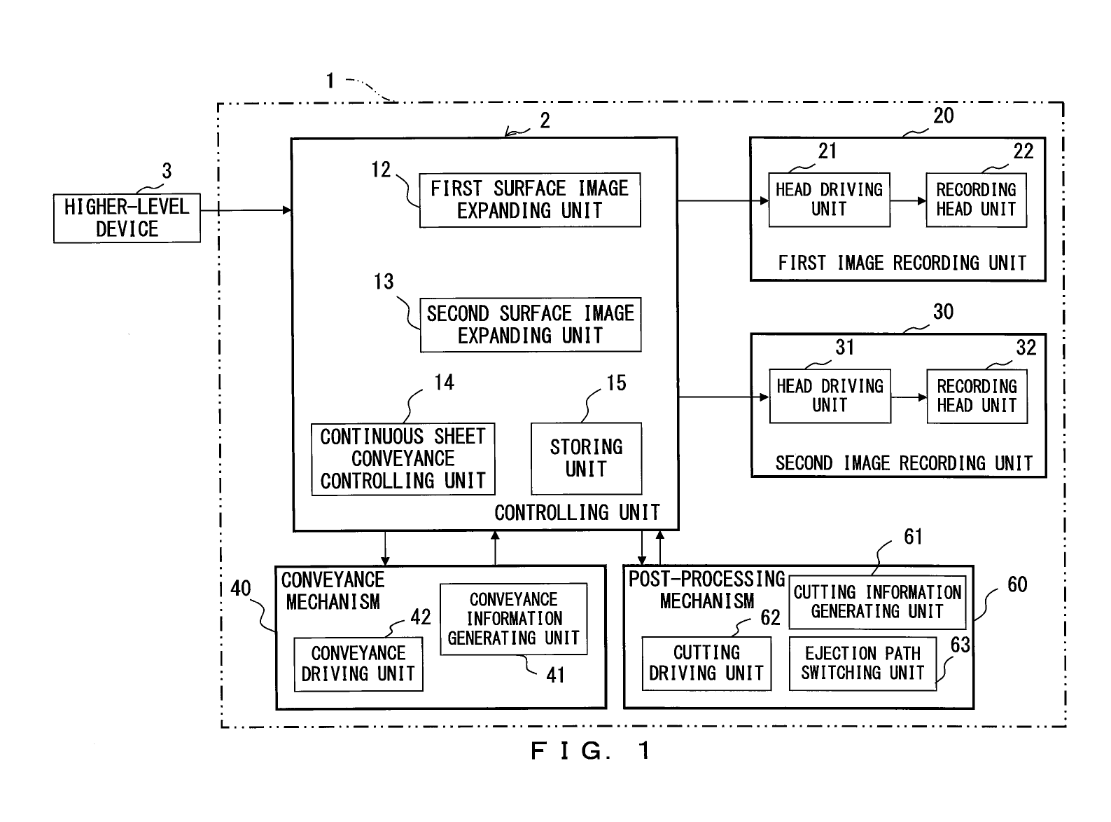

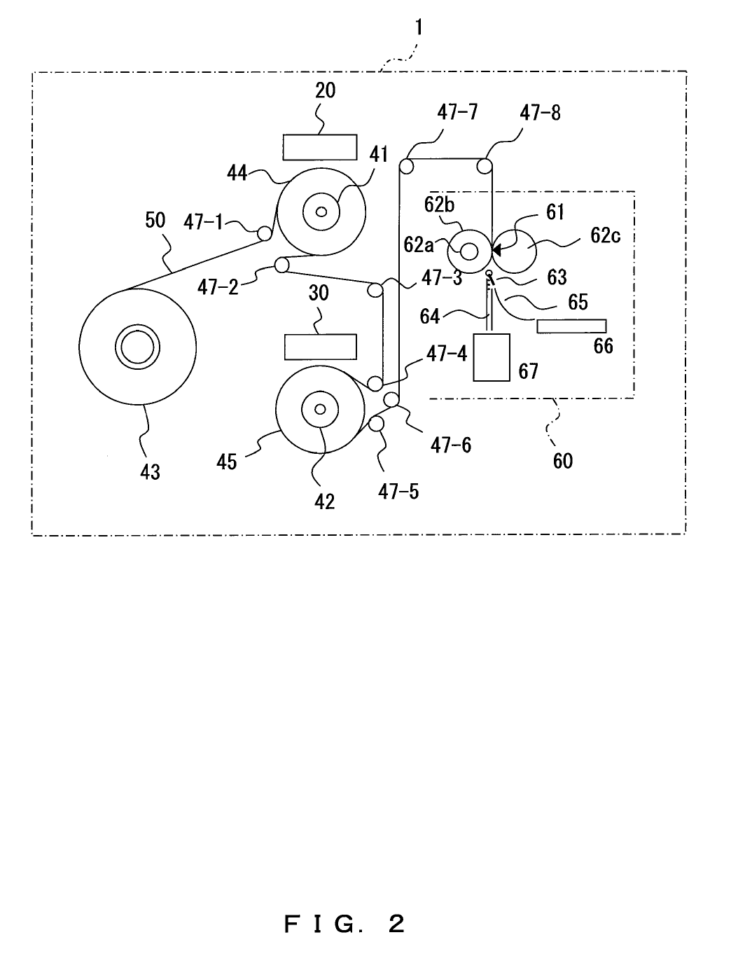

FIG. 1 illustrates an image recording apparatus according to an embodiment as a conceptual block configuration. FIG. 2 schematically illustrates an arrangement configuration of the image recording apparatus according to the embodiment.

The image recording apparatus 1 according to the embodiment is configured by including at least a controlling unit 2, a first image recording unit 20, a second image recording unit 30, a conveyance mechanism 40, and a post-processing mechanism 60.

The controlling unit 2 includes at least a processing circuit and a nonvolatile memory. Here, the processing circuit is configured, for example, with an arithmetic processing unit, such as an MPU (Micro Processor Unit), having a control function and a computation function, a ROM (Read Only Memory) for storing a control program, a RAM (Random. Access Memory) that serves as a working memory of the MPU, and the like. The nonvolatile memory stores setting values and the like related to a control of the image recording apparatus 1.

The controlling unit 2 includes at least a first surface image expanding unit 12, a second surface image expanding unit 13, a continuous sheet conveyance controlling unit 14, and a storing unit 15. In the controlling unit 2, the storing unit 15 is configured, for example, with a nonvolatile memory. Moreover, in the controlling unit 2, a control program is prestored, for example, in the ROM. The MPU is caused to read and execute the control program, whereby the controlling unit 2 is caused to function as the first surface image expanding unit 12, the second surface image expanding unit 13, and the continuous sheet conveyance controlling unit 14.

A higher-level device 3 is connected, for example, via a LAN (Local Area Network) or the like as an external device of the image recording apparatus 1 according to the embodiment. The higher-level device 3 corresponds to a computer operated by a user who causes the image recording apparatus 1 according to the embodiment to execute an image recording process. The higher-level device 3 notifies the image recording apparatus 1 according to the embodiment of job information as information about the image recording process. The job information includes at least recording data (here, data of a plurality of pages of both surfaces) to be recorded when the image recording process is executed, and the total number of pages on which the image recording process is to be executed. Upon receipt of the job information from the higher-level device 3, the controlling unit 2 of the image recording apparatus 1 causes the storing unit 15 to store the job information as image recording information.

Upon receipt of the job information from the higher-level device 3, the controlling unit 2 extracts the recording data from the job information. Next, the controlling unit 2 divides the recording data into recording data for recording a first surface image and recording data for recording a second surface image. The controlling unit 2 transfers these pieces of recording data to the first surface image expanding unit 12 and the second surface image expanding unit 13, respectively.

Upon receipt of the recording data for recording the first surface image, the first surface image expanding unit 12 executes an expansion process for expanding the recording data into a dot image of each page, and for storing and holding the dot image in a first bitmap memory (BMM), not illustrated, within the first surface image expanding unit 12. The first surface image expanding unit 12 also executes a process for incrementing the value of a first surface image expanded page counter by 1 each time the recording data is expanded into a dot image of one page. Moreover, the first surface image expanding unit 12 executes a process for incrementing the value of a first surface BMM holding page counter by 1 each time the dot image of one page is stored in the first BMM. Accordingly, the value of the first surface BMM holding page counter indicates a value (first surface count value) obtained by counting the number of pages of the dot image (first surface expanded image data) held in the first BMM by the expansion process executed by the first screen expanding unit 12.

The first image recording unit 20 executes a recording process on a first surface of a continuous sheet 50 by causing a head driving unit 21 to drive a recording head unit 22 so that the recording head unit 22 jets ink onto the first surface on the basis of a dot image of the first surface, which is read from the first BMM within the first surface image expanding unit 12.

Similarly to the first surface image expanding unit 12, upon receipt of the recording data for recording the second surface image, the second surface image expanding unit 13 executes an expansion process for expanding the recording data into a dot image of each page, and for storing and holding the dot image in a second BMM, not illustrated, within the second surface image expanding unit 13. The second surface image expanding unit 13 also executes a process for incrementing the value of a second surface image expanded page counter by 1 each time the recording data is expanded into a dot image of one page. Moreover, the second surface image expanding unit 13 executes a process for incrementing the value of a second surface BMM holding page counter by 1 each time the dot image of one page is stored in the second BMM. Accordingly, the value of the second surface BMM holding page counter indicates a value (second surface count value) obtained by counting the number of pages of the dot image (second surface expanded image data) held in the second BMM by the expansion process executed by the second surface image expanding unit 13.

The first BMM and the second BMM may be separate semiconductor memories. Alternatively, different storage areas in one semiconductor memory may be allocated as the first BMM and the second BMM, respectively.

The second image recording unit 30 executes a recording process for a second surface (a surface reverse to the first surface) of the continuous sheet 50 by causing a head driving unit 31 to drive a recording head unit 32 so that the recording head unit 32 jets ink on the basis of the dot image read from the second BMM within the second surface image expanding unit 13.

The controlling unit 2 includes all of the first surface image expanded page counter, the second surface image expanded page counter, the first surface BMM holding page counter, and the second surface BMM holding page counter. Here, the controlling unit 2 also executes a process for respectively decrementing the value of the first surface BMM holding page counter and that of the second surface BMM holding page counter by 1 each time the second image recording unit 30 terminates the recording process on the second surface of the continuous sheet 50.

The conveyance mechanism 40 is a medium conveying unit for conveying the continuous sheet 50, which is a recording medium. The conveyance mechanism 40 is configured by including at least a conveyance information generating unit 41 and a conveyance driving unit 42 having a motor.

Here, conveyance operations of the conveyance mechanism 40 and recording operations of the first image recording unit 20 and the second image recording unit 30 are described with reference to FIG. 2.

A continuous sheet feeding unit 43 holds the continuous sheet 50 to be rotatable, and is arranged as a winding unit for winding off the continuous sheet 50 to a first continuous sheet supporter 44. In this embodiment, the continuous sheet feeding unit 43 holds roll paper as the continuous sheet 50.

The continuous sheet feeding unit 43 is provided with a powder clutch, not illustrated, that uses magnetic powder in order to transmit torque, and the continuous sheet feeding unit 43 functions to apply a predetermined back tension by applying torque in a direction reverse to the conveyance direction of the continuous sheet 50.

When the continuous sheet 50 conveyed from the continuous sheet feeding unit 43 is introduced, the conveyance mechanism 40 conveys the continuous sheet 50, which passes through a guide roller 47-1, immediately below the first image recording unit 20 by winding and holding the continuous sheet 50 with the first continuous sheet supporter 44. Then, the conveyance mechanism 40 winds and holds the continuous sheet 50, the first surface of which has been recorded by the first image recording unit 20, with a second continuous sheet supporter 45 after the continuous sheet 50 passes through guide rollers 47-2, 47-3 and 47-4, and the conveyance mechanism 40 conveys the continuous sheet 50 immediately below the second image recording unit 30. Thereafter, the conveyance mechanism 40 conveys the continuous sheet 50, the second surface of which has been recorded by the second image recording unit 30, to the post-processing mechanism 60 after the continuous sheet 50 passes through guide rollers 47-5, 47-6, 47-7 and 47-8.

The first continuous sheet supporter 44 is configured, for example, with a drum made of aluminum, and can wind the continuous sheet 50 at a predetermined winding angle. To the continuous sheet 50, a vertical drag is applied from an outer circumference of the first continuous sheet supporter 44 with tensions on upstream and downstream sides of the conveyance direction of the first continuous sheet supporter 44. Accordingly, the continuous sheet 50 is held by the first continuous sheet supporter 44 according to a frictional force between the first continuous sheet supporter 44 and the continuous sheet 50. The first continuous sheet supporter 44 is configured as a driven drum. The first continuous sheet supporter 44 is rotated with the rotation of the second continuous sheet supporter 45 via the continuous sheet 50.

To a rotational axis of the first continuous sheet supporter 44, a conveyance information generating unit 41 is linked. When the rotational axis of the conveyance information generating unit 41 rotates with the rotation of the first continuous sheet supporter 44, the conveyance information generating unit 41 outputs a detection pulse corresponding to a rotational position of the first continuous sheet supporter 44. The detection pulse is input to the first image recording unit 20 and the second image recording unit 30 via the controlling unit 2 or the like. The conveyance information generating unit 41 in the image recording apparatus 1 according to the embodiment is configured by including a rotary encoder, and the conveyance information generating unit 41 is configured so that an image of one line is recorded per single pulse according to a resolution of the continuous sheet 50 in the conveyance direction.

Also, the second continuous sheet supporter 45 has a configuration similar to the first continuous sheet supporter 44, and can wind the continuous sheet 50 at a predetermined winding angle. A vertical drag is applied to the continuous sheet 50 from an outer circumference of the second continuous sheet supporter 45 with tensions on upstream and downstream sides of the conveyance direction of the second continuous sheet supporter 45. Accordingly, the continuous sheet 50 is held by the second continuous sheet supporter 45 according to a frictional force between the second continuous sheet supporter 45 and the continuous sheet 50. The second continuous sheet supporter 45 is configured as a driving drum, and conveys the continuous sheet 50 with the driving force of the conveyance driving unit 42.

The post-processing mechanism 60 is described next. The post-processing mechanism 60 cuts the continuous sheet 50, the first and the second surfaces of which have been recorded, at predetermined intervals, and ejects cut sheets.

The post-processing mechanism 60 includes a cutting information generating unit 61, a cutting driving unit 62, and an ejection path switching unit 63.

The cutting driving unit 62 is configured by including a cutting roller driving motor 62a, a cutting driving roller 62b, and a cutting driven roller 62c.

The perimeter of the cutting driving roller 62b is 420 mm in length, and is provided with two blades (spiral cutters) on the perimeter. Since the two blades are arranged at an interval of 210 mm, they cut the continuous sheet 50 at a unit length of 210 mm by rotating the cutting driving roller 62b in synchronization with the conveyance speed of the continuous sheet 50. The image recording apparatus 1 according to the embodiment is described by being assumed to use continuous paper having a width of 297 mm as the continuous sheet 50, and to cut and eject the continuous sheet 50 in an A4 size (297 mm×210 mm) that is a paper size standard.

The cutting roller driving motor 62a is configured, for example, with a servo motor, and is driven by providing a pulse train signal from the controlling unit 2 to the post-processing mechanism 60. The cutting roller driving motor 62a may be configured with a stepping motor as a replacement for the servo motor.

The cutting information generating unit 61 generates cutting information that indicates the cut timing of the continuous sheet 50, and is configured, for example, with a cutting origin sensor. The cutting information generating unit 61 is arranged at a position where the blades possessed by the cutting driving roller 62b cut the continuous sheet 50. The cutting information generating unit 61 detects a timing at which the cutting driving roller 62b cuts the continuous sheet 50 with the blades, and notifies the controlling unit 2 of the detected timing as cutting information.

According to an instruction issued from the continuous sheet conveyance controlling unit 14, the ejection path switching unit 63 switches an ejection path of the continuous sheet 50 cut by the cutting driving roller 62b between a path leading to an ejection table 66 and a path leading to a waste medium collection box 67. The ejection path switching unit 63 leads, to the waste medium collection box 67, an unnecessary sheet and a blank sheet (a sheet on which the image recording process is not executed from among cut continuous sheets 50) that are generated before and after the image recording process. In the meantime, the ejection path switching unit 63 leads, to the ejection table 66, a sheet on which the image recording process has been executed from among the cut continuous sheets 50. An ejection path 65 from the ejection path switching unit 63 to the ejection table 66, and a waste medium ejection path 64 from the ejection path switching unit 63 to the waste medium collection box 67, are respectively provided. Via these paths, the continuous sheets 50 after being cut are ejected smoothly.

Control process operations of the continuous sheet conveyance controlling unit 14 are described next. The MPU of the controlling unit 2 reads and executes the control program stored in the ROM, whereby the controlling unit 2 functions as the continuous sheet conveyance controlling unit 14.

The continuous sheet conveyance controlling unit 14 initially controls the conveyance mechanism 40 to start conveying the continuous sheet 50. Here, the continuous sheet conveyance controlling unit 14 determines the timing at which to start conveying the continuous sheet 50 as follows.

Firstly, the continuous sheet conveyance controlling unit 14 monitors the first surface image expanded page counter, the second surface image expanded page counter, the first surface BMM holding page counter, and the second surface BMM holding page counter, and determines the following two conditions.

Condition 1: Whether or not both the value (first surface count value) of the first surface BMM holding page counter and the value (second surface count value) of the second surface BMM holding page counter exceed a stipulated value N.

Condition 2: Whether or not both the value of the first surface image expanded page counter and the value of the second surface image expanded page counter reach a total number, presented in the job information, of pages on which the image recording process is to be executed.

Here, the continuous sheet conveyance controlling unit 14 does not cause the conveyance mechanism 40 to start conveying the continuous sheet 50 until either of the two conditions is satisfied. Then, the continuous sheet conveyance controlling unit 14 causes the conveyance mechanism 40 to start conveying the continuous sheet 50 at a timing at which at least one of the two conditions is determined to be satisfied.

Thereafter, upon recognizing that the conveyance speed of the continuous sheet 50 conveyed by the conveyance mechanism 40 is stabilized at a predetermined value on the basis of an interval between detection pulses transmitted from the conveyance information generating unit 41 to the controlling unit 2, an instruction to start the image recording process is issued from the controlling unit 2.

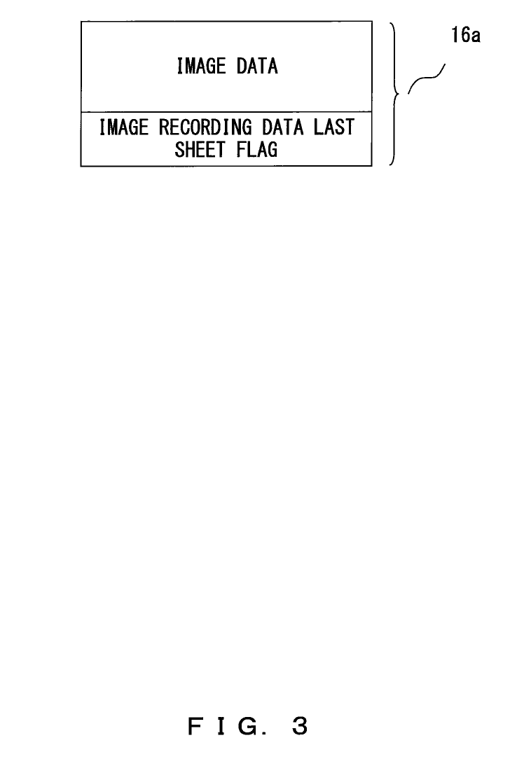

Additionally, the continuous sheet conveyance controlling unit 14 generates sheet information concurrently with the above described conveyance control of the continuous sheet 50. FIG. 3 illustrates a data structure of the sheet information.

As illustrated in FIG. 3, the sheet information 16a includes at least an area for storing image data and an area for storing an image recording data last sheet flag. Here, in the area for storing image data, one pair of pieces of dot image data of the front and the back surfaces, which is read in units of pages and is held in the first BMM within the first surface image expanding unit 12 and in the second BMM within the second surface image expanding unit 13, is stored. In contrast, in the area for storing an image recording data last sheet flag, a predetermined flag is set if the dot image data stored in the area for storing image data is the last process target in the image recording process executed on the basis of the job information received from the higher-level device 3.

The continuous sheet conveyance controlling unit 14 causes a sheet information queue 16 to form, waiting for the image recording to store and hold the generated sheet information 16a. The sheet information queue 16 waiting for the image recording is secured in advance in a predetermined storage area within the storing unit 15.

Additionally, upon receipt of the cutting information, detected by the cutting information generating unit 61, of the continuous sheet 50 cut by the post-processing mechanism 60, the continuous sheet conveyance controlling unit 14 generates cut portion synchronization information 51, which is synchronized with the cutting information, for determining the timing of the image recording on a succeeding portion of the continuous sheet 50. The generated cut portion synchronization information 51 is stored in a predetermined storage area within the storing unit 15.

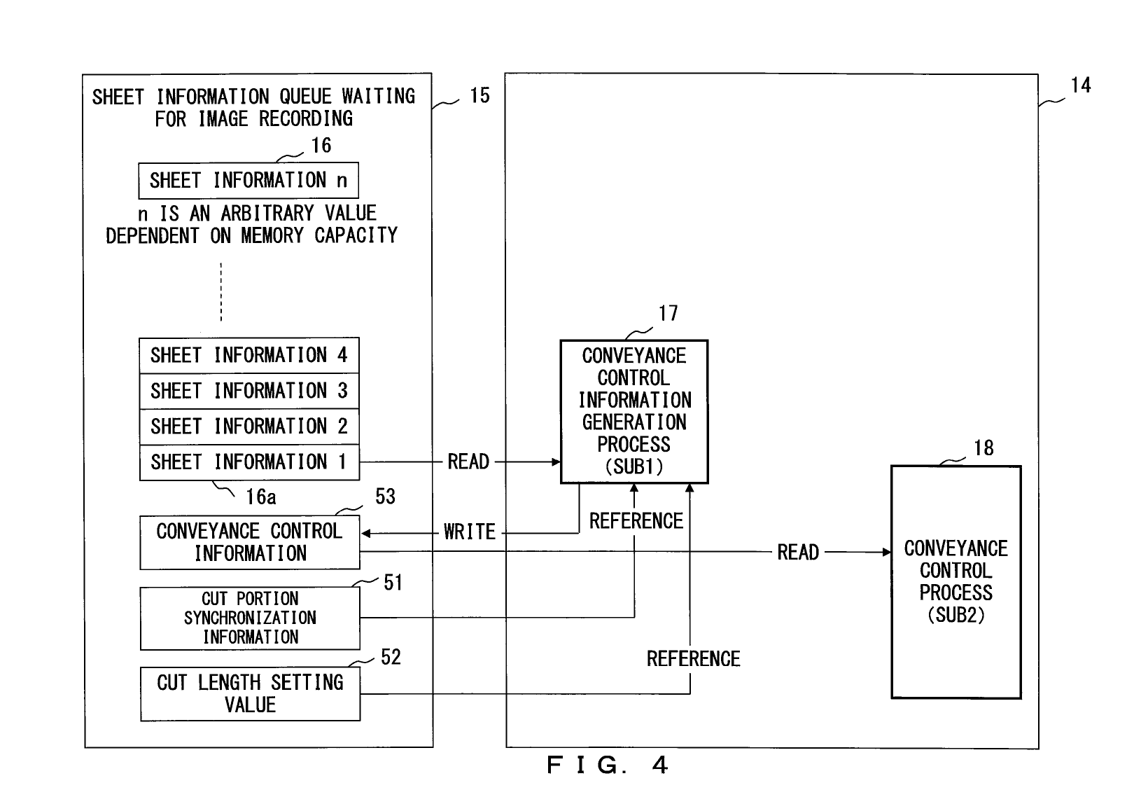

Upon receipt of the instruction to start the image recording process, the continuous sheet conveyance controlling unit 14 starts a conveyance control information generation process and a conveyance control process concurrently with the above described operations. These processes are described with reference to FIG. 4.

As illustrated in FIG. 4, the conveyance control information generation process (SUB1) 17 is a process for reading the sheet information 16a held in the sheet information queue 16 waiting for the image recording, for referencing the cut portion synchronization information 51, and for generating conveyance control information 53 on the basis of these pieces of information. The conveyance control information 53 generated by this process is written to a predetermined storage area within the storing unit 15. In contrast, the conveyance control process (SUB2) 18 is a process for reading the conveyance control information 53 from the storing unit 15, and for causing the first image recording unit 20 and the second image recording unit 30 to execute the image recording process at a timing specified in the read conveyance control information 53.

The conveyance control information generation process (SUB1) 17 is further described.

Once this process is started, the continuous sheet conveyance controlling unit 14 initially executes a process for determining whether or not a conveyance control can be performed by the conveyance control process (SUB2) 18. Here, the state where the conveyance control can be performed means the state where the conveyance control process (SUB2) 18 does not execute the control process for the image recording process of the first image recording unit 20 or the second image recording unit 30.

The continuous sheet conveyance controlling unit 14 executes a process for monitoring a remaining amount of the sheet information queue 16 waiting for the image recording if it is determined in this determination process that the conveyance control can be performed. Then, on the basis of a result of the monitoring, the continuous sheet conveyance controlling unit 14 executes a process for determining whether or not at least one of two predetermined conditions is satisfied. One of the two conditions is that a predetermined number of pieces of the sheet information 16a remain in the sheet information queue 16 waiting for the image recording. The other of the two conditions is that the sheet information 16a about the last sheet of the image recording data be included in the sheet information queue 16 waiting for the image recording.

If it is determined that at least one of the two conditions described above is satisfied, the continuous sheet conveyance controlling unit 14 executes a process for reading the sheet information 16a from the sheet information queue 16 waiting for the image recording in a FIFO (First In First Out) order. Then, the continuous sheet conveyance controlling unit 14 executes a process for generating the conveyance control information 53 on the basis of the read sheet information 16a and a result of referencing the cut portion synchronization information 51, and for writing the generated conveyance control information 53 in a predetermined storage area within the storing unit 15.

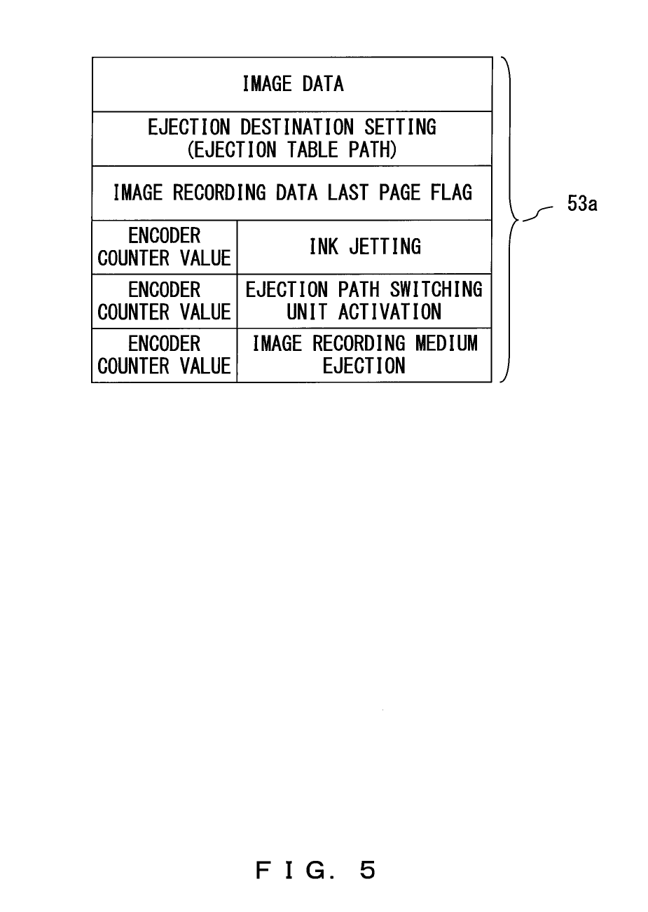

The conveyance control information 53 illustrated in FIG. 4 collectively represents the conveyance control information 53a generated for respective pieces of the sheet information 16a. FIG. 5 illustrates a data structure of the conveyance control information 53a.

As illustrated in FIG. 5, the conveyance control information 53a stores control information needed for the control processes executed in the image recording process for each sheet and the execution timings of the control processes.

In FIG. 5, in the area for storing image data, one pair of pieces of dot image data of the front and the back surfaces stored in the area for storing image data in the sheet information 16a is copied and stored unchanged. Moreover, information indicating a selection of the path leading to the ejection table 66 is stored in an area for storing an ejection destination setting as switching control information for the ejection path switching unit 63. Moreover, in the area for storing an image recording data last sheet flag, the same flag is set only when the above described predetermined flag is set in the area for storing an image recording data last sheet flag in the sheet information 16a.

Additionally, in FIG. 5, in areas for storing ink jetting, ejection path switching unit activation and image recording medium ejection, count values, counted by the controlling unit 2, of detection pulses detected by the conveyance information generating unit 41 are presented. These values respectively indicate ink jetting start timing of the recording head units 22 and 32 when the image recording process for the dot image data stored in the area for storing image data is executed, switching timing of the ejection paths (the switching control timing of the ejection path switching unit 63) of the sheet on which the image recording process has been executed (the continuous sheet 50 after being cut), and ejection timing of the sheet, on which the image recording process has been executed, to the ejection table 66.

Additionally, the continuous sheet conveyance controlling unit 14 executes a process for updating the cut portion synchronization information 51 to the count value that indicates the image recording start timing of a succeeding sheet of the continuous sheet 50 each time the cutting information generated by the cutting information generating unit 61 is reported to the controlling unit 2 with the execution of the conveyance control information generation process (SUB1) 17. With this update process, synchronization of the image recording timing of the succeeding sheet of the continuous sheet 50 with the cutting information generated by the cutting information generating unit 61 is maintained. The cut portion synchronization information 51 is updated according to the following equation.

Nt=Ct+Lenc

In the above described equation, Nt is the count value that indicates the cut portion synchronization information 51 after being updated, namely, the image recording timing of a sheet next to the most recently image-recorded sheet. Moreover, Ct is the count value that indicates the image recording timing of the most recently image-recorded sheet. Moreover, Lenc is the count value, which corresponds to a conveyance distance of one sheet of the continuous sheet 50, of the detection pulse generated by the conveyance information generating unit 41. Note that Lenc is preset in a predetermined area within the storing unit 15 as a cut length setting value 52.

The conveyance control information generation process (SUB2) 18 is further described next.

Once this process is started, the continuous sheet conveyance controlling unit 14 initially executes a process for reading the conveyance control information 53a generated by the conveyance control information generation process (SUB1) 17 from the storing unit 15. At the same time, the continuous sheet conveyance controlling unit 14 executes a process for monitoring the information (the count value of the detection pulse) generated by the controlling unit 2 on the basis of the detection pulse provided from the conveyance information generating unit 41 within the conveyance mechanism 40.

Here, the continuous sheet conveyance controlling unit 14 executes a process for executing the control processes if the count value of the detection pulse detected by the conveyance information generating unit 41 matches the count value indicating the execution timing of the control process of the image recording (ink jetting) indicated by the read conveyance control information 53a, the ejection path switching unit activation, or the image recording medium ejection. Here, if the control process to be executed is the ejection path switching unit activation process, the continuous sheet conveyance controlling unit 14 executes a control process for switching the ejection path switching unit 63 to the path leading to the ejection table 66 on the basis of the information presented in the area for storing an ejection destination setting in the conveyance control information 53a.

Upon completion of the above described conveyance control information generation process (SUB2) 18 for one piece of the conveyance control information 53a, the continuous sheet conveyance controlling unit 14 enters a state in which it is able to newly perform conveyance control for the next piece of the conveyance control information 53a.

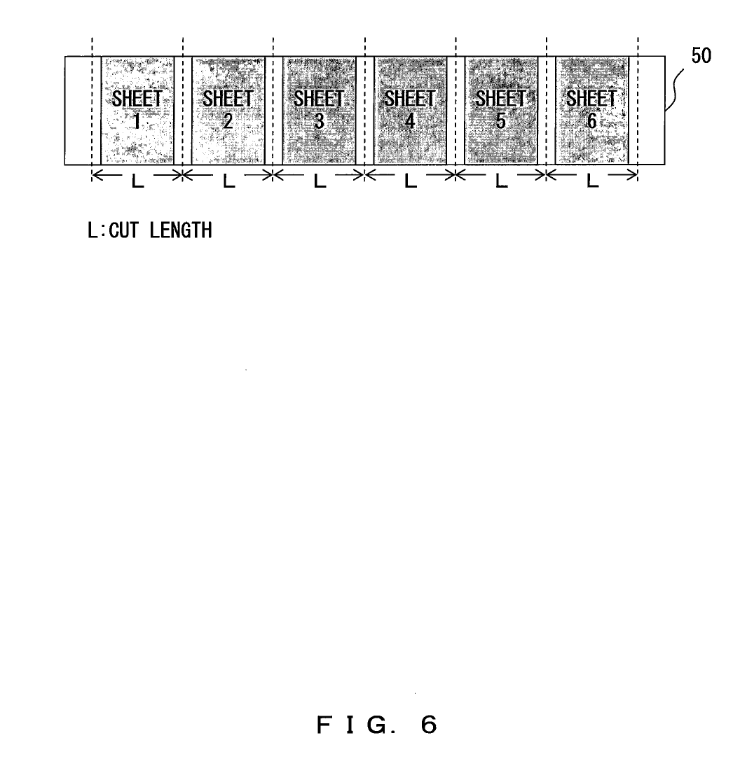

Under normal conditions in which a delay does not occur in the expansion processes executed by the first surface image expanding unit 12 and the second surface image expanding unit 13, the continuous sheet conveyance controlling unit 14 repeatedly executes the above described process. With the repetitions of this process, images of respective pages are successively recorded on the continuous sheet 50 in order of the pages as schematically illustrated in FIG. 6, and the continuous sheet 50 is cut into pages at a cut length L and ejected to the ejection table 66.

The continuous sheet conveyance controlling unit 14 executes the above described process under normal conditions after executing the conveyance control information generation process (SUB1) 17 and the conveyance control information generation process (SUB2) 18. In the meantime, the continuous sheet conveyance controlling unit 14 executes the following process under abnormal conditions where the image recording is not expected to be successively executed on the continuous sheet 50 due to a delay of an image recording data transfer from the higher-level device 3 or a processing delay or the like caused by an increase in a load within the image recording apparatus 1.

Namely, the continuous sheet conveyance controlling unit 14 that is executing the conveyance control information generation process (SUB1) 17 executes a process for determining whether or not the remaining amount of the sheet information queue 16 waiting for the image recording is less than a predetermined threshold value, if the conveyance control process (SUB2) 18 is in a state in which it is able to perform conveyance control. However, this determination process is skipped if the sheet information 16a where the image recording data last sheet flag is set is included in the sheet information queue 16 waiting for the image recording. This process is executed as follows.

Namely, the continuous sheet conveyance controlling unit 14 initially executes a process for counting the number of pieces of the sheet information 16a, held in the sheet information queue 16 waiting for the image recording, for first surface image recording and second surface image recording, and for calculating the sum of the counted values. Here, the number of pieces of the sheet information 16a for the first surface image recording is the count value of the number of pages of the dot image of the first surface, whereas the number of pieces of the sheet information 16a for the second surface image recording is the count value of the number of pages of the dot image of the second surface. The continuous sheet conveyance controlling unit 14 executes a process for calculating the sum of the count value of the number of pages of the first surface expanded image data obtained (held?) by the expansion process of the first surface image expanding unit 12, and the count value of the number of pages of the second surface expanded image data held by the expansion process of the second surface image expanding unit 13. A result of this calculation is the remaining amount of the sheet information queue 16 waiting for the image recording.

Next, the continuous sheet conveyance controlling unit 14 executes a largeness/smallness comparison process for comparing the remaining amount with a predetermined threshold value. Here, the threshold value is set to the number of pages on which the image recording apparatus 1 can perform the normal image recording within an expansion processing time that is experimentally identified in advance and needed for the expansion processes of the first surface image expanding unit 12 and the second surface image expanding unit 13.

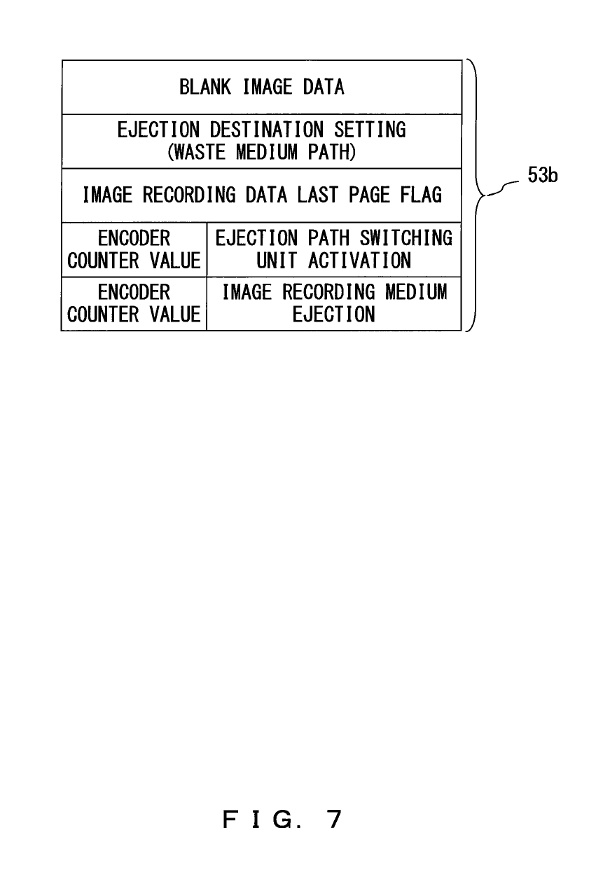

Here, the continuous sheet conveyance controlling unit 14 determines that a delay has occurred in the time needed for the expansion processes executed by the first surface image expanding unit 12 and the second surface image expanding unit 13 if the remaining amount of the sheet information queue 16 waiting for the image recording is less than the predetermined threshold value as a result of the largeness/smallness comparison process. In this case, the continuous sheet conveyance controlling unit 14 executes a process for generating conveyance control information 53b, illustrated in FIG. 7, for generating a blank sheet instead of reading the conveyance control information 53a from the storing unit 15, and for writing the generated conveyance control information 53b in a predetermined storage area within the storing unit 15.

In a blank image data storage area in the conveyance control information 53b for generating a blank sheet, which is illustrated in FIG. 7, data (such as null data) that does not cause the recording head units 22 and 32 to jet ink is stored for safety. Moreover, in an ejection destination setting storage area, information indicating a selection of the path leading to the waste medium collection box 67 is stored as switching control information for the ejection path switching unit 63. Note that an area for storing an image recording data last sheet flag is not used for the conveyance control information 53b for generating a blank sheet.

Additionally, in storage areas of ejection path switching unit activation and image recording medium ejection in FIG. 7, the count values of the detection pulse that is generated by the conveyance information generating unit 41 and that is counted by the controlling unit 2 are presented. These values represent switching timing (switching control timing of the ejection path switching unit 63) of the ejection path of a blank sheet (the continuous sheet 50 after being cut), and ejection timing of a blank sheet to the waste medium collection box 67. Since ink jetting is not performed, an ink jetting start timing storage area does not exist in the conveyance control information 53b for generating a blank sheet.

The continuous sheet conveyance controlling unit 14 executes a process for updating the cut portion synchronization information 51 to a count value that represents the image recording start timing of a succeeding sheet of the continuous sheet 50 each time the cutting information generated by the cutting information generating unit 61 is reported to the controlling unit 2. This update process is similar to that under normal conditions. The continuous sheet conveyance controlling unit 14 executes this update process with the execution of the conveyance control information generation process (SUB1) 17. With this update process, synchronization of the image recording timing of the succeeding sheet of the continuous sheet 50 with the cutting information generated by the cutting information generating unit 61 is maintained.

In contrast, under abnormal conditions, the continuous sheet conveyance controlling unit 14 that is executing the conveyance control process (SUB2) 18 executes the following process.

Namely, the continuous sheet conveyance controlling unit 14 executes a process for reading, from the storing unit 15, the conveyance control information 53b for generating a blank sheet, which is generated with the conveyance control information generation process (SUB1) 17. At the same time, the continuous sheet conveyance controlling unit 14 executes a process for monitoring information (the count value of the detection pulse) generated by the controlling unit 2 on the basis of the detection pulse from the conveyance information generating unit 41 within the conveyance mechanism 40.

The continuous sheet conveyance controlling unit 14 executes the control processes if the count value of the detection pulse generated by the conveyance information generating unit 41 matches the count value that indicates the execution timing, which is presented in the read conveyance control information 53b, of the control process of the ejection path switching unit activation or the image recording medium ejection. Here, since information about the execution timing of the image recording (ink jetting) is not stored in the conveyance control information 53b, the image recording is not performed on the continuous sheet 50. If the control process to be executed is the activation process of the ejection path switching unit, the continuous sheet conveyance controlling unit 14 executes the control process for switching the ejection path switching unit 63 to the path leading to the waste medium collection box 67 on the basis of the information presented in the ejection destination setting storage area in the conveyance control information 53b.

Upon completion of the above described conveyance control information generation process (SUB2) 18 for one piece of the conveyance control information 53b, the continuous sheet conveyance controlling unit 14 enters a state in which it is able to perform new conveyance control for the next piece of the conveyance control information 53a or 53b.

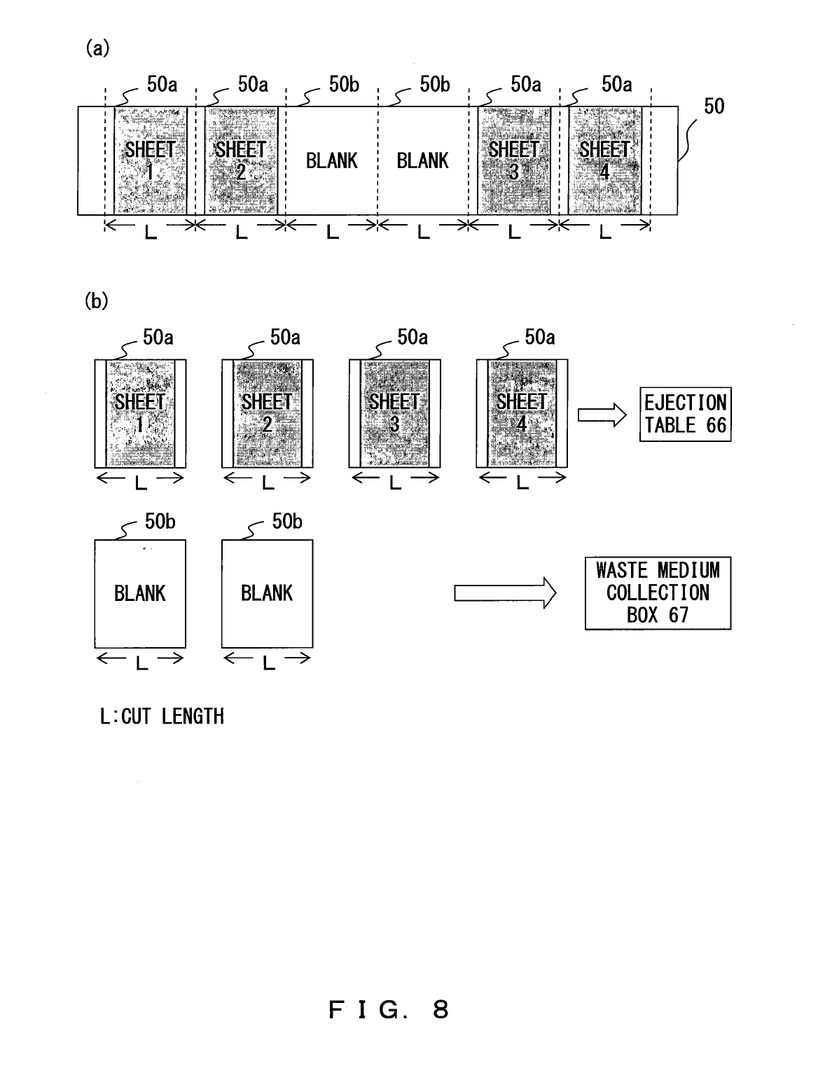

Under abnormal conditions where a delay that exceeds a predetermined expansion processing time occurs in the expansion processes executed by the first surface image expanding unit 12 and the second surface image expanding unit 13, the continuous sheet conveyance controlling unit 14 repeatedly executes the above described process. With the repetitions of this process, an unrecorded portion (blank sheet) on which the image recording process is not executed is generated on the continuous sheet 50 while images of respective pages are successively recorded in order of the pages, as schematically illustrated as (a) in FIG. 8.

Thereafter, when the continuous sheet 50 is cut into pages, a sheet 50a on which the image recording has been performed is ejected to the ejection table 66, and a sheet 50b that is a blank sheet on which the image recording is not performed is collected by the waste medium collection box 67 as schematically illustrated as (b) in FIG. 8.

A length of the unrecorded portions thus generated on the continuous sheet 50 in the conveyance direction of the continuous sheet 50 is a value according to the number of successive pieces of the conveyance control information 53b for generating a blank sheet, as schematically illustrated as (b) in FIG. 8. More specifically, this length is an integer multiple of a conveyance distance (namely, the cut length in (b) of FIG. 8) of the continuous sheet 50, which corresponds to the cutting interval of the continuous sheet 50 cut by the post-processing mechanism 60. Moreover, if a predetermined number of blank sheets are successively generated, an abnormality is detected to occur in the process of any piece of image recording data. Therefore, the continuous sheet conveyance controlling unit 14 may execute a notification process for notifying a user of an occurrence of the abnormality, for example, by making an error display on a display unit not illustrated.

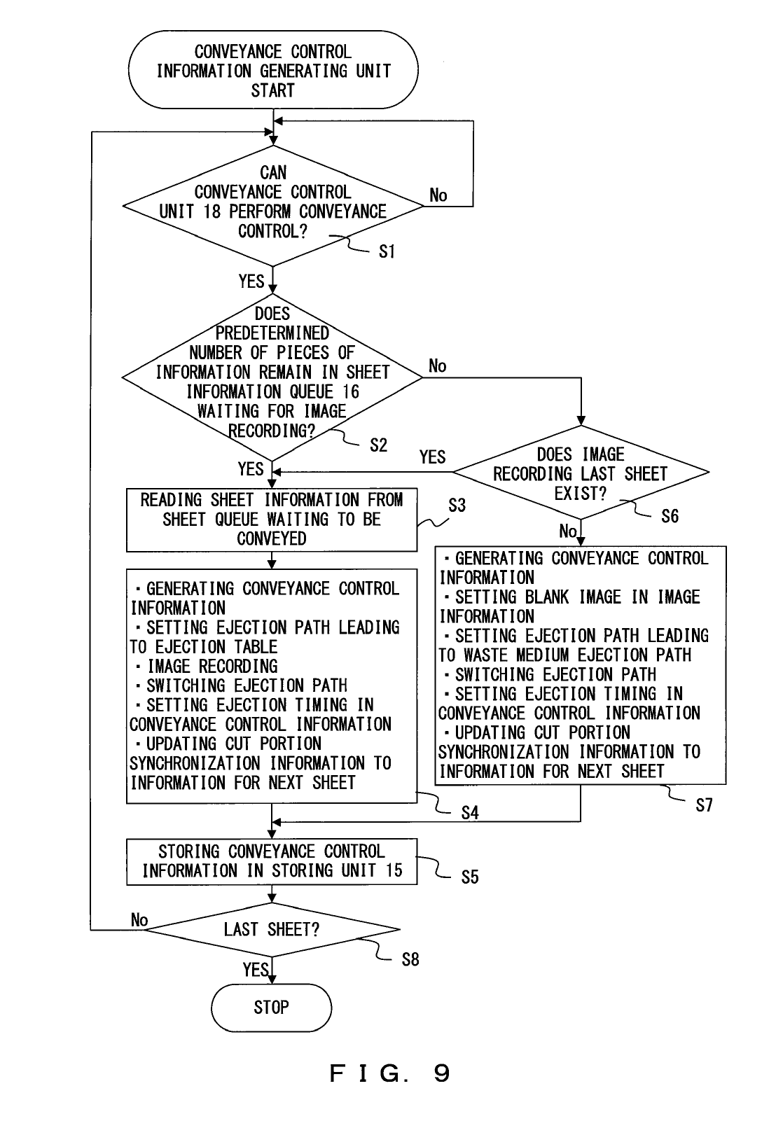

FIG. 9 is described next. FIG. 9 is a flowchart illustrating a generation process of the conveyance control information 53 in the conveyance control information generation process (SUB1) 17 executed by the controlling unit 2.

The process illustrated in FIG. 9 is implemented in such a way that the MPU of the controlling unit 2 reads and executes the control program pre stored in the ROM of the controlling unit 2.

Once the image recording is started, the controlling unit 2 initially executes a process for determining in step S1 whether or not the conveyance control process (SUB2) 18 is in a state in which it is able to perform the conveyance control. Here, if the controlling unit 2 determines that the conveyance control process (SUB2) 18 is in the state in which it is able to perform the conveyance control (if the determination results in “YES”), the process goes to step S2. Alternatively, if the controlling unit 2 determines that the conveyance control process (SUB2) 18 is not in the state in which it is able to perform the conveyance control (if the determination results in “NO”), the process of step S1 is repeated until the controlling unit 2 determines that the conveyance control process (SUB2) 18 enters the state in which it is able to perform the conveyance control (until the determination results in “YES”).

Next, in step S2, the controlling unit 2 executes a process for determining whether or not an amount of the sheet information 16a equal to or greater than a predetermined threshold value remains in the sheet information queue 16 waiting for the image recording. Here, if the controlling unit determines that an amount of the sheet information 16a equal to or greater than the predetermined threshold value remains (the determination results in “YES”), the process goes to step S3. Alternatively, if the controlling unit determines that an amount of the sheet information 16a less than the predetermined value remains (the determination results in “NO”), the process goes to step S6.

Next, the controlling unit 2 executes a process for reading the sheet information 16a from the sheet information queue 16 waiting for the image recording in a FIFO order in step S3.

Then, the controlling unit 2 references the cut portion synchronization information 51 stored in the storing unit 15 in step S4. The controlling unit 2 executes a process for generating the conveyance control information 53a including the ink jetting start timing, the switching control timing of the ejection path switching unit 63, and the ejection timing of a sheet on which the image recording process has been executed, and sending it to the ejection table 66 as described above. The generation of the conveyance control information 53a is performed on the basis of the sheet information 16a read with the process of step S3, and is a result of referencing the cut portion synchronization information 51.

Next, the controlling unit 2 executes a process for writing the generated conveyance control information 53a in a predetermined storage area within the storing unit 15 in step S5. Thereafter, the controlling unit 2 determines whether or not the current sheet is the last sheet in step S8. If the current sheet is not the last sheet, the process goes back to step S1. Then, the controlling unit 2 repeats the above described processes. If the current sheet is the last sheet, the process is stopped.

In the meantime, if the controlling unit 2 determines that an amount of the sheet information 16a less than the predetermined threshold value remains in the above described determination process of step S2 (if the determination results in “NO”), the process goes to step S6. Then, the controlling unit 2 executes a process for determining in step S6 whether or not the sheet information 16a where the image recording data last flag is set is included within the sheet information queue 16 waiting for the image recording. Here, if the controlling unit 2 determines that the sheet information 16a where the flag is set is included within the sheet information queue 16 waiting for the image recording (if the determination results in “YES”), the process goes back to the above described step S3. Then, the controlling unit 2 executes a process for generating the conveyance control information 53a for the image recording. In contrast, if the controlling unit 2 determines that the sheet information 16a where the flag is set is not included within the sheet information queue 16 waiting for the image recording (if the determination results in “NO”), the process goes to step S7.

Next, the controlling unit references the cut portion synchronization information 51 stored in the storing unit 15 in step S7. Then, the controlling unit 2 executes a process for generating the conveyance control information 53b for generating a blank sheet which includes the switching control timing of the ejection path switching unit 63 and the ejection timing of the sheet on which the image recording process has been executed, and sending it to the waste medium collection box 67 on the basis of a result of the reference as described above. Thereafter, the process goes back to step S5, and the controlling unit 2 executes a process for writing the generated conveyance control information 53b in a predetermined storage area within the storing unit 15. The continuous sheet conveyance controlling unit 14 that is executing the conveyance control process (SUB) 18 executes the control process according to the conveyance control information 53b written by this process, whereby the post-processing mechanism 60 is controlled after a blank sheet is generated. According to this control, the ejection path of the blank sheet cut by the post-processing mechanism 60 is switched from the ejection path 65 to the ejection table 66 to the waste medium ejection path 64.

Thereafter, the process goes back to step S1, and the controlling unit 2 repeats the above described processes. Accordingly, if the delay of the expansion processes executed by the first surface image expanding unit 12 and the second surface image expanding unit 13 is determined to be resolved with the processes of steps S2 and S6 to be executed hereafter, the processes of steps S3 and S4 are executed. As a result, the image recording process executed by controlling the recording heads 22 and 32 in synchronization with the cutting information generated by the cutting information generating unit 61 is restarted.

The process described up to this point is the process for generating the conveyance control information 53.

As described above, the image recording apparatus 1 can continue the image recording with a minimized amount of extra paper output without stopping the conveyance of a recording medium that is the continuous sheet 50 even if a delay occurs in image recording timing during the image recording due to a delay in an image data transfer or a delay in the image recording control process.

The present invention is not limited to the above described embodiment, and can be modified in diverse ways within a scope that does not depart from the gist of the present invention in an implementation phase.

What is claimed is:

1. An image recording apparatus that includes an image expanding unit for executing an expansion process for expanding, into a dot image of each page, recording data of a plurality of pages on which an image recording process is to be executed and for holding the dot image, and that executes the image recording process by jetting ink onto a continuous sheet, which is a conveyed recording medium, from a recording head on the basis of the dot image, comprising:
a post-processing mechanism having at least a cutting information generating unit for generating cutting information that indicates cutting timing of the continuous sheet, for cutting the continuous sheet at predetermined intervals; and
a continuous sheet conveyance controlling unit for determining whether or not a delay has occurred within an expansion processing time that is identified in advance for the image expanding unit and is needed for the expansion process on the basis of a count value obtained by counting the number of pages of expanded image data held by the expansion process executed by the image expanding unit, and for generating on the continuous sheet an unrecorded portion on which the image recording process is not executed if it is determined that the delay has occurred, wherein
the continuous sheet conveyance controlling unit generates the unrecorded portion on the continuous sheet in synchronization with the cutting information generated by the cutting information generating unit.

2. The image recording apparatus according to claim 1, wherein
the continuous sheet conveyance controlling unit sets a length of the unrecorded portion generated on the continuous sheet in a conveyance direction of the continuous sheet to an integer multiple of a conveyance distance of the continuous sheet which corresponds to a cutting interval of a portion that is not the unrecorded portion of the continuous sheet cut by the post-processing mechanism.

3. The image recording apparatus according to claim 1, wherein
the continuous sheet conveyance controlling unit determines whether or not the delay is resolved after the unrecorded portion is generated, and restarts the image recording process by controlling the recording head in synchronization with the cutting information generated by the cutting information generating unit if it is determined that the delay is resolved.

4. The image recording apparatus according to claim 1, wherein
the post-processing mechanism includes an ejection path switching unit for switching an ejection destination of the continuous sheet after the continuous sheet is cut, and
the continuous sheet conveyance controlling unit switches an ejection path of the unrecorded portion cut by the post-processing mechanism to a path different from the ejection path of the continuous sheet that does not include the unrecorded portion cut by the post-processing mechanism by controlling the ejection path switching unit when the unrecorded portion is generated on the continuous sheet.

5. The image recording apparatus according to claim 1, wherein
the image expanding unit includes a first surface image expanding unit and a second surface image expanding unit which execute an expansion process for expanding into a dot image of each page recording data of a plurality of pages of both surfaces on which the image recording process is to be executed, and for holding the dot image for each of the surfaces,
the image recording process is executed on both of the surfaces of the conveyed continuous sheet, and
the continuous sheet conveyance controlling unit determines whether or not a delay has occurred in an expansion processing time that is identified in advance for each of the first surface image expanding unit and the second surface image expanding unit and is needed for the expansion process on the basis of a first surface count value obtained by counting the number of pages of first surface expanded image data held by the expansion process executed by the first surface image expanding unit and a second surface count value obtained by counting the number of pages of second surface expanded image data held by the expansion process executed by the second surface image expanding unit, and generates the unrecorded portion, on which the image recording process is not executed, on the continuous sheet while maintaining a page layout relationship between a first surface and a second surface if it is determined that the delay has occurred.

6. The image recording apparatus according to claim 1, further comprising
a controlling unit including at least the continuous sheet conveyance controlling unit, wherein
the controlling unit is configured by including at least an arithmetic processing unit and a storing unit for pre-storing a control program, and
the controlling unit functions as the continuous sheet conveyance controlling unit by causing the processor to execute the control program.

7. A controlling method of an image recording apparatus that includes an image expanding unit for executing an expansion process for expanding into a dot image of each page recording data of a plurality of pages on which an image recording process is to be executed and for holding the dot image, and that executes the image recording process by jetting ink onto a continuous sheet that is a conveyed recording medium from a recording head on the basis of the dot image, the image recording apparatus including at least a cutting information generating unit for generating cutting information that indicates a cutting timing of the continuous sheet, and a post-processing mechanism for cutting the continuous sheet at predetermined intervals, the controlling method comprising:
determining whether or not a delay has occurred within an expansion processing time that is identified in advance for the image expanding unit and that is needed for an expansion process on the basis of a count value obtained by counting the number of pages of expanded image data held by the expansion process executed by the image expanding unit; and
generating an unrecorded portion, on which the image recording process is not executed, on the continuous sheet in synchronization with cutting information generated by the cutting information generating unit if it is determined that the delay has occurred.

8. The controlling method according to claim 7, wherein
a length of the unrecorded portion generated on the continuous sheet in a conveyance direction of the continuous sheet is set to an integer multiple of a conveyance distance which corresponds to a cutting interval of the continuous sheet of a portion that is not the unrecorded portion of the continuous sheet cut by the post-processing mechanism.

9. The controlling method according to claim 7, further comprising:
determining whether or not the delay is resolved, after the unrecorded portion is generated, and
restarting the image recording process by controlling the recording head in synchronization with the cutting information generated by the cutting information generating unit if it is determined that the delay is resolved.

10. The controlling method according to claim 7, wherein
the post-processing mechanism further includes an ejection path switching unit for switching an ejection destination of the continuous sheet after the continuous sheet is cut, and
the controlling method further comprising switching the ejection path of the unrecorded portion cut by the post-processing mechanism to a path different from the ejection path of the continuous sheet that does not include the unrecorded portion cut by the post-processing mechanism by controlling the ejection path switching unit when the unrecorded portion is generated on the continuous sheet.

11. The controlling method according to claim 7, wherein
the image expanding unit includes a first surface image expanding unit and a second surface image expanding unit which execute an expansion process for expanding into a dot image of each page recording data of a plurality of pages of both of surfaces on which the image recording process is to be executed, and for holding the dot image for each of the surfaces,
the image recording process is executed on both of the surfaces of the conveyed continuous sheet, and
the controlling method further comprising:
determining whether or not a delay has occurred in an expansion processing time that is identified in advance for each of the first surface image expanding unit and the second surface image expanding unit and is needed for the expansion process on the basis of a first surface count value obtained by counting the number of pages of first surface expanded image data held by the expansion process executed by the first surface image expanding unit and a second surface count value obtained by counting the number of pages of second surface expanded image data held by the expansion process executed by the second surface image expanding unit; and
generating the unrecorded portion, on which the image recording process is not executed, on the continuous sheet while maintaining a page layout relationship between a first surface and a second surface if it is determined that the delay has occurred.
